(19) United States
(12) Patent Application Publication
(10) Pub. No.: US 2009/0012987 A1
(43) Pub. Date: Jan. 8, 2009

(54) METHOD AND SYSTEM FOR DELIVERING ROLE-APPROPRIATE POLICIES

(76) Inventors: David L. KAMINSKY, Chapel Hill, NC (US); A. Steven KRANTZ, Sherman Oaks, CA (US); Indrajit PODDAR, Sewickley, PA (US)

Correspondence Address: DILLON & YUDELL LLP, 8911 N. CAPITAL OF TEXAS HWY., SUITE 2110, AUSTIN, TX, 78759, US

(21) Appl. No.: 11/773,645

(22) Filed: Jul. 5, 2007

(51) Int. Cl. G06F 3/01; G06F 17/30

(52) U.S. Cl. 707/102; 715/744; 707/E17.009

(57) ABSTRACT

A method of delivering role-appropriate policies. A policy management utility registers a policy in a policy directory that includes a pointer corresponding to a data storage location of the policy and metadata corresponding to the policy. The policy management utility stores the metadata and the pointer in the policy directory, which includes references to policy sources and policy artifacts that correspond to the policy sources. When a user requests information related to a policy, the policy management utility matches the role of the requestor with one of multiple pre-defined corporate roles stored in the policy directory. The policy management utility generates a role-appropriate view in a graphical user interface (GUI). The role-appropriate view corresponds to the role of the requester. The policy management utility provides information related to the policy request within the role-appropriate view.

### BACKGROUND OF THE INVENTION

The present invention relates in general to data processing systems and in particular to using computers to view internal business policies.

Businesses typically use a wide range of policies to govern internal business processes. As utilized herein, a policy refers to a set of declarations designed to guide decisions about one or more courses of action. Conventional businesses document policies in various formats, including, but not limited to web pages, contracts, corporate directives, regulations, service agreements, run books, and best practices. Furthermore, policies are stored in different locations, such as on internal web sites and in enterprise software.

Policies are typically enforced by automated systems that use low level rules to restrict access to different types of business data. Low level rules are derived from higher level policy sources, such as company-wide security policy guidelines. High level policy sources are associated with policy artifacts that include policy targets and policy compliance data. Policy targets can include either subjects (e.g., system users) or resources (e.g., web sites). Over time, policy enforcement processes generate policy compliance data, which also needs to be stored for audit purposes.

Problems can occur when searching for linkages between related policy sources and policy artifacts when policy sources and policy artifacts are numerous and/or vary between policy domains. Conventional enterprise software therefore provides customizable role-based views (e.g., security, legal, and financial views). However, when an administrator prepares to take action based on a policy or a derived rule, it can be difficult to ensure that the action complies with all applicable policies or to determine which role-based views should receive policy updates. It is also difficult to identify the downstream effects and specific sources of high level policy updates. Furthermore, if all policies are delivered to all people in all roles, administrators have little hope of digesting such a large amount of information and extracting relevant information for audit purposes.

### SUMMARY OF AN EMBODIMENT

Disclosed are a method, system, and computer program product for delivering role-appropriate policies. A policy management utility registers a policy in a policy directory that includes a pointer corresponding to a data storage location of the policy and metadata corresponding to the policy. The policy management utility stores the metadata and the pointer in the policy directory, which includes references to policy sources and policy artifacts that correspond to the policy sources. When a user requests information related to a policy, the policy management utility matches the role of the requester with one of multiple pre-defined corporate roles stored in the policy directory. The policy management utility generates a role-appropriate portal view in a graphical user interface (GUI). The role-appropriate portal view corresponds to the role of the requester. The policy management utility provides information related to the policy request within the role-appropriate portal view.

The present invention thus provides an overall policy management infrastructure that contains references to policies in different domains. The policy management utility captures the hierarchical relationship between policy sources and artifacts by storing pointers to policy repositories and metadata corresponding to policies in the policy directory. The policy management utility uses taxonomies stored within the policy directory to categorize policies specifically for different roles and to easily retrieve all related policy sources and metadata appropriate to the roles of different users.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary computer, according to an embodiment of the present invention;

FIG. 2 illustrates an exemplary policy directory, according to an embodiment of the present invention; and

FIG. 3 is a high level logical flowchart of an exemplary method of delivering role-appropriate policies, according to an embodiment of the invention.

### DETAILED DESCRIPTION OF AN ILLUSTRATIVE EMBODIMENT

The present invention provides a method, system, and computer program product for using computers to deliver role-appropriate policies to different employees based on internal business policies.

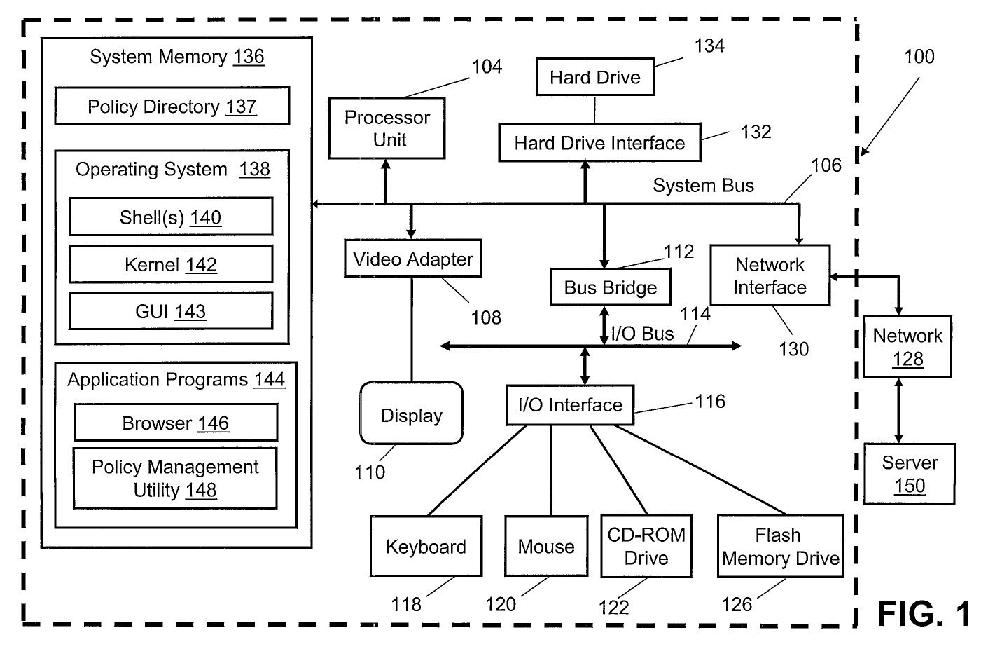

With reference now to FIG. 1, there is depicted a block diagram of an exemplary computer 100, with which the present invention may be utilized. Computer 100 includes processor unit 104 that is coupled to system bus 106. Video adapter 108, which drives/supports display 110, is also coupled to system bus 106. System bus 106 is coupled via bus bridge 112 to Input/Output (I/O) bus 114. I/O interface 116 is coupled to I/O bus 114. I/O interface 116 affords communication with various I/O devices, including keyboard 118, mouse 120, Compact Disk-Read Only Memory (CD-ROM) drive 122, and flash memory drive 126. The format of the ports connected to I/O interface 116 may be any known to those skilled in the art of computer architecture, including but not limited to Universal Serial Bus (USB) ports.

Computer 100 is able to communicate with server 150 via network 128 using network interface 130, which is coupled to system bus 106. Network 128 may be an external network such as the Internet, or an internal network such as a Local Area Network (LAN), an Ethernet, or a Virtual Private Network (VPN). In one embodiment, server 150 is configured similarly to computer 100.

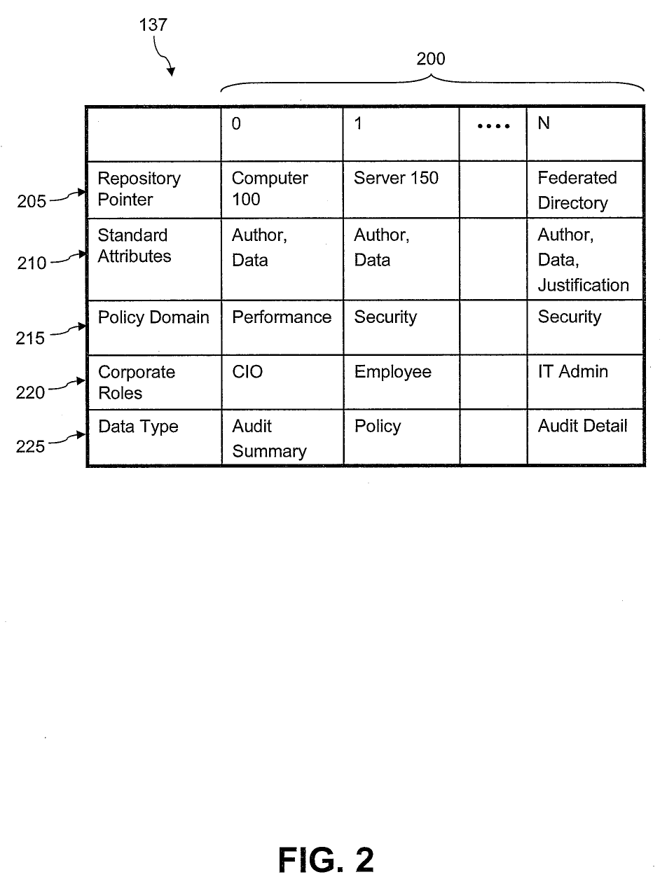

Hard drive interface 132 is also coupled to system bus 106. Hard drive interface 132 interfaces with hard drive 134. In one embodiment, hard drive 134 populates system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Data that populates system memory 136 includes Operating System (OS) 138, application programs 144, and policy directory 137. Policy directory 137 includes references to multiple policies. Policy directory 137 is illustrated in FIG. 2, which is discussed below. In another embodiment, policy directory 137 may be stored in server 150 or another storage device.

OS 138 includes shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes graphical user interface (GUI) 143 and kernel 142, which includes lower levels of functionality for OS 138. Kernel 142 provides essential services required by other parts of OS 138 and application programs 144. The services provided by kernel 142 include memory management, process and task management, disk management, and I/O device management.

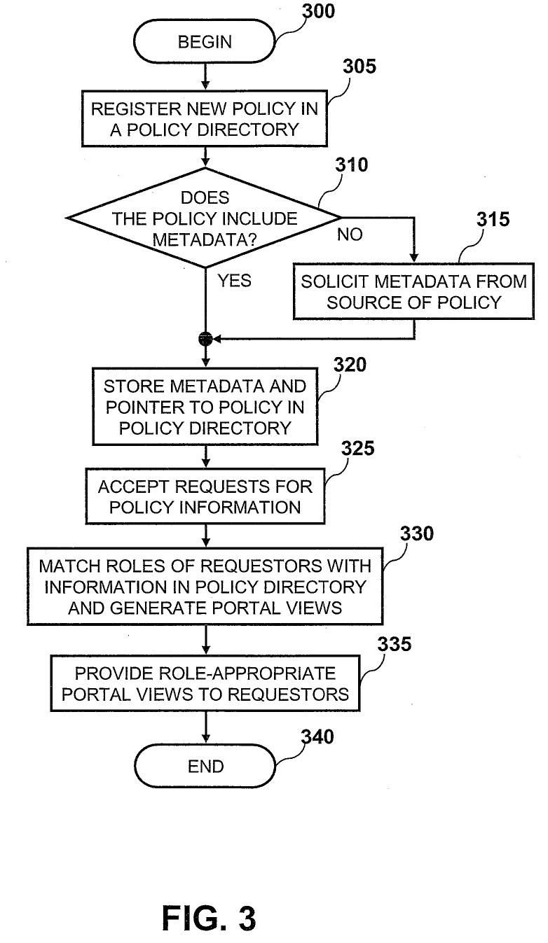

Application programs 144 include browser 146 and policy management utility 148. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Policy management utility 148 performs the functions illustrated in FIG. 3, which is discussed below.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

With reference now to FIG. 2, there is depicted an exemplary policy directory, according to an embodiment of the present invention. As shown, policy directory 137 includes N data columns 200, where N is an integer corresponding to the number of policies stored within policy directory 137. Data columns 200 thus each include data that corresponds to a different policy. Policy directory 137 includes a data field for repository pointer 205. As utilized herein, a repository refers to a physical location containing policy data, while a directory refers to a memory location that includes references to policies stored in one or more repositories. In one embodiment, repository pointer 205 includes pointer values that identify a specific storage device located in computer 100, server 150, or connected to network 128. Repository pointer 205 may also include general pointer values to computer 100, server 150, another similar computer connected to network 128, and/or a federated directory (i.e., a logical directory spread across multiple repositories).

According to the illustrative embodiment, policy directory 137 includes metadata for standard attributes 210, such as the author of a policy, policy-related data, and/or a policy justification. Policy directory 137 also includes metadata for policy domain 215, corporate roles 220, and data type 225. Policy domain 215 corresponds to the type of a policy (e.g., security or performance based). Corporate roles 220 refer to the level and/or amount of information accessible to a user of policy directory 137. Corporate roles 220 include, but are not limited to, Chief Information Officer (CIO), CIO's office, general employee, supervisor, Human Resources (HR), Information Technology (IT) operations, IT manager, and IT administrator. Data type 225 refers to the data manipulation ability corresponding to corporate role 220 (e.g., summary view, policy entry, audit detail view, and audit summary view). In one embodiment, each user view appears differently in GUI 143 based on the user's corporate role 220. For example, a general employee may be able to view organization-wide policies but may not be able to view password-related data, while an IT administrator may be able to view password-related data and/or GUI 143 may contain additional buttons corresponding to password editing functions only accessible by an IT administrator.

As utilized herein, a summary view refers to a view within GUI 143 that includes general information on multiple policies. A policy entry view refers to a view within GUI 143 that includes one or more data entry fields and/or an edit button that enables a user to add new policies or change existing policies. An audit detail view refers to a view within GUI 143 that includes detailed information for multiple policies, including, but not limited to, names of policy authors, policy creation times, historical policy update/edit times, applicable corporate roles 220, and a history of policy violation incidents. Similarly, an audit summary view refers to a view within GUI 143 that includes general information on the enforcement of multiple policies and/or a history of policy violation incidents. For example, such a summary can be created by counting instances of a particular violation type and presenting that count instead of listing individual violations. Other well-known data summary techniques can similarly be applied.

According to the illustrative embodiment, the data field of repository pointer 205 that corresponds to policy 0 indicates that policy 0 is stored in computer 100. The data fields of corporate roles 220 and data type 225 indicate that policy 0 is accessible to the CIO via an audit summary view. Similarly, policy 1 is stored in server 150 and is accessible to employees via a general policy view. Policy N is stored in a federated directory (i.e., spread across multiple locations) and is accessible to IT administrators via the audit detail view.

Turning now to FIG. 3, there is illustrated a high level logical flowchart of an exemplary method of delivering role-appropriate policies, according to an embodiment of the invention. The process begins at block 300 in response to the generation of a policy. Policy management utility 148 registers a new policy in policy directory 137, as depicted in block 305. At block 310, policy management utility 148 determines whether a new policy includes metadata. If the new policy does not include metadata, policy management utility 148 obtains metadata from the source of the new policy (i.e., a user or application that generated the policy), as shown in block 315, and the process proceeds to block 320. If the new policy already includes metadata, policy management utility 148 stores the metadata in policy directory 137, as depicted in block 320.

Policy management utility 148 accepts requests for policy information from users of computer 100, server 150, and/or other computers connected via network 128, as shown in block 325. A user may request policy information that includes pointers to policy source data, information on the user's job role, audit data, rules derived from a policy, and pointers to policy automation tools. In an alternate embodiment, policy management utility 148 may consult audit logs and provide summaries when a user requests role-appropriate summary data. For example, a CIO may only want to see a percentage of non-compliant actions corresponding to a policy rather than an entire list of non-compliant actions corresponding to the policy.

Policy management utility 148 matches the role of each requester with corporate roles 220 in policy directory 137, and policy management utility 148 generates role-appropriate portal views for each user within GUI 143 based on the corresponding corporate roles 220, as depicted in block 330. Policy management utility 148 subsequently provides role-appropriate policy information via the role-appropriate portal views within GUI 143, as shown in block 335, and the process terminates at block 340.

In an alternate embodiment, policy directory 137 may include an extensible markup language (XML) based registry, such as a Universal Description Discovery and Integration (UDDI) platform that includes policy data for multiple corporate roles 220. Different levels of policy abstractions for various roles may be represented in a UDDI registry (e.g., as XML “tModels”). Similarly, different taxonomies may be defined in a UDDI registry that enables policy management utility 148 to categorize policy abstractions and define hierarchical relationships between policies and metadata. In another embodiment, a UDDI inquiry Application Programming Interface (API) may be used to issue precise searches for different corporate roles 220 based on pre-defined classification schemes and to retrieve WebServices fetching-related artifacts. WebServices that fetch various policy artifacts may be registered in a UDDI registry.

The present invention thus provides an overall policy management infrastructure that contains references to policies in different domains. Policy management utility 148 captures the hierarchical relationship between policy sources and artifacts by storing pointers to policy repositories and metadata corresponding to policies in policy directory 137. Policy management utility 148 uses taxonomies stored within policy directory 137 to categorize policies specifically for different roles and to easily retrieve all related policy sources and metadata appropriate to the roles of different users.

It is understood that the use herein of specific names are for example only and not meant to imply any limitations on the invention. The invention may thus be implemented with different nomenclature/terminology and associated functionality utilized to describe the above devices/utility, etc., without limitation.

In the flow chart (FIG. 3) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution. Examples of the types of media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

1. A method comprising:
registering a policy in a policy directory, wherein said policy directory includes:
a pointer corresponding to a data storage location of said policy;
metadata corresponding to said policy; and
a plurality of references to policy sources and policy artifacts that correspond to said policy sources;
storing said metadata and said pointer in said policy directory;
in response to a request for information related to a policy:
matching a requestor role with one of a plurality of pre-defined corporate roles in the policy directory;
generating a role-appropriate view in a graphical user interface (GUI), wherein said role-appropriate view corresponds to said requestor role and said role-appropriate view is matched to said requestor role from among a plurality of other views; and
providing said information limited by said requestor role and related to said policy within said role-appropriate view.

2. (canceled)

3. A computer system comprising:
a processor;
a network interface coupled to said processor, wherein said network interface enables said computer system to communicate with a server via a network;
a system memory coupled to said processor;
a policy directory within said system memory; and
a policy management utility within said system memory that provides the functions of:
registering a policy in said policy directory, wherein said policy directory includes:
a pointer corresponding to a data storage location of said policy;
metadata corresponding to said policy; and
a plurality of references to policy sources and policy artifacts that correspond to said policy sources;
storing said metadata and said pointer in said policy directory;
providing within the policy directory an extensible markup language (XML) based registry, including a Universal Description Discovery and Integration (UDDI) platform that includes policy data for multiple corporate roles;
enabling different levels of policy abstractions for various roles within a UDDI registry, wherein the levels are provided as XML “tModels”;
defining different taxonomies in the UDDI registry that enables a policy management utility to categorize policy abstractions and define hierarchical relationships between policies and metadata;
in response to a request for information related to a policy:
matching a requestor role with one of a plurality of pre-defined corporate roles in said policy directory;
generating a role-appropriate view in a graphical user interface (GUI), wherein said role-appropriate view corresponds to said requestor role and said role-appropriate view is matched to said requestor role from among a plurality of other views; and
providing said information limited by said requestor role and related to said policy within said role-appropriate view.

4. (canceled)

5. A computer program product comprising:
a computer storage medium; and
program code on said computer storage medium that that when executed provides the functions of:
registering a policy in said policy directory, wherein said policy directory includes:
a pointer corresponding to a data storage location of said policy;
metadata corresponding to said policy; and
a plurality of references to policy sources and policy artifacts that correspond to said policy sources;
storing said metadata and said pointer in said policy directory;
providing within the policy directory an extensible markup language (XML) based registry, including a Universal Description Discovery and Integration (UDDI) platform that includes policy data for multiple corporate roles;
enabling different levels of policy abstractions for various roles within a UDDI registry, wherein the levels are provided as XML “tModels”;
defining different taxonomies in the UDDI registry that enables a policy management utility to categorize policy abstractions and define hierarchical relationships between policies and metadata;
in response to a request for information related to a policy:
matching a requestor role with one of a plurality of pre-defined corporate roles in a policy directory;
generating a role-appropriate view in a graphical user interface (GUI), wherein said role-appropriate view corresponds to said requestor role and said role-appropriate view is matched to said requestor role from among a plurality of other views; and
providing said information limited by said requestor role and related to said policy within said role-appropriate view.

6. (canceled)

7. The method of claim 1, further comprising:
providing within the policy directory an extensible markup language (XML) based registry, including a Universal Description Discovery and Integration (UDDI) platform that includes policy data for multiple corporate roles;
enabling different levels of policy abstractions for various roles within a UDDI registry, wherein the levels are provided as XML “tModels”; and
defining different taxonomies in the UDDI registry that enables a policy management utility to categorize policy abstractions and define hierarchical relationships between policies and metadata.

8. The method of claim 1, further comprising:
providing a UDDI inquiry Application Programming Interface (API) to (a) issue precise searches for different corporate roles based on pre-defined classification schemes and to (b) retrieve WebServices fetching-related artifacts; and
registering the WebServices to fetch the various policy artifacts in the UDDI registry.
